(19) United States
(12) Patent Application Publication
(10) Pub. No.: US 2015/0081967 A1
(43) Pub. Date: Mar. 19, 2015

(54) MANAGEMENT OF STORAGE READ REQUESTS

(71) Applicant: Hewlett-Packard Development Company, L.P., Houston, TX (US)

(72) Inventor: Weimin Pan, Spring, TX (US)

(73) Assignee: Hewlett-Packard Development Company, L.P., Houston, TX (US)

(21) Appl. No.: 14/030,930

(22) Filed: Sep. 18, 2013

(51) Int. Cl. G06F 3/06

(52) U.S. Cl. CPC G06F 3/0656; G06F 3/0689; G06F 3/0619
USPC 711/114

(57) ABSTRACT

A storage controller to receive from a host multiple read requests to read sets of data blocks from a data storage device. The storage controller to determine whether the read requests include non-continuous addresses associated with a set of non-requested data blocks between sets of requested data blocks and a gap of a number of non-requested data blocks is less than a pre-defined threshold. If the read requests have non-continuous addresses and a gap of a number of non-requested data blocks is less than the pre-defined threshold, then generate a single read request to retrieve from a storage device the non-requested and requested data blocks, and directly write the retrieved requested data blocks to a host buffer, and write the retrieved non-requested data blocks to a cache memory on a storage controller.

### BACKGROUND

Some storage systems include a network or interconnection of hosts, storage controllers and storage devices configured for hosts to communicate with storage controllers to gain access to storage devices. The storage controllers may handle requests from the hosts to read data from and write data to the storage devices.

### BRIEF DESCRIPTION OF THE DRAWINGS

Examples are described in the following detailed description and in reference to the drawings, in which:

FIG. 1 depicts an example block diagram of a system for management of storage read requests in accordance with an example of the techniques of the present application.

FIG. 2 depicts an example flow chart of a process for management of storage read requests in accordance with an example of the techniques of the present application.

FIG. 3 depicts an example diagram of management of storage read requests in accordance with an example of the techniques of the present application.

FIG. 4 depicts an example block diagram showing a non-transitory, computer-readable medium that stores instructions for management of storage read requests accordance with an example of the techniques of the present application.

### DETAILED DESCRIPTION

Some storage systems include a network or interconnection of hosts, storage controllers and storage devices configured to allow hosts to communicate with storage controllers to gain access to data of storage devices. The storage controllers may handle requests from the hosts to read data from and write data to the storage devices. The storage devices may be hard disk drives and may be configured as storage volumes which may allow the host to interface with storage using a logical address and without having to have knowledge of the physical layout or structure of the storage devices. The host may send multiple read requests to the storage controller which the controller then processes to access to the storage device. In some cases, the host may generate read requests that may include requests with continuous addresses that are without address gaps of data blocks stared on the storage device. In this case, the storage controller may combine the host read requests together to retrieve the requested data blocks from the storage device without much impact on performance.

On the other hand, in some other cases, the host may generate read requests that may include requests that area non-continuous that have discontinuous addresses with address gaps of data blocks stored on the storage device. In this case, the storage controller may generate multiple read requests to retrieve the requested data blocks from the storage device but such requests may have a negative impact on performance. That is, the performance associated with small address gaps between two read operations may be worse than performance associated with large read operations. Therefore, there may be a need for techniques to reduce storage device access, such as disk drive access, which may improve performance associated with small host read operations. As explained below, in one example, techniques of the present application may help reduce storage device operations by coalescing of grouping non-continuous or discontinuous multiple small read requests together as single large read requests or operations.

In one example, the present application describes techniques that may reduce storage device operations by coalescing or grouping non-continuous or discontinuous multiple small read requests together as a single large read requests or operations. In one example, a storage controller may be configured to receive from a host multiple read requests to read sets of data blocks from a data storage device. The storage controller may determine whether the read requests include non-continuous addresses associated with a set of non-requested date stocks located between sets of requested data blocks and whether a gap of a number of non-requested data blocks is less than a pre-defined threshold. If the read requests have non-continuous addresses and a gap of a number of non-requested data blocks is less than the pre-defined threshold, then the storage controller may generate a single read request to retrieve from the storage device the non-requested and requested data blocks.

The storage controller may be configured to then directly write the retrieved requested data blocks to a host buffer, and not write the retrieved non-requested data blocks to the host buffer. Instead, the storage controller may write the non-requested data blocks to a cache memory associated with the storage controller to allow for return of the data blocks back to the host in case of a subsequent host read request. In this manner, the storage controller may allow for the return of the data from the cache memory to the host in case of a subsequent host read request. The storage controller may be able to avoid having to generate another read request directed to storage device which may improve performance. On other the hand, if the read request have continuous addresses and gap of a number of non-requested data blocks is greater than the pre-defined threshold, than the storage controller, instead of a generating a single read request, generates multiple read requests to retrieve only the requested data blocks from the storage device.

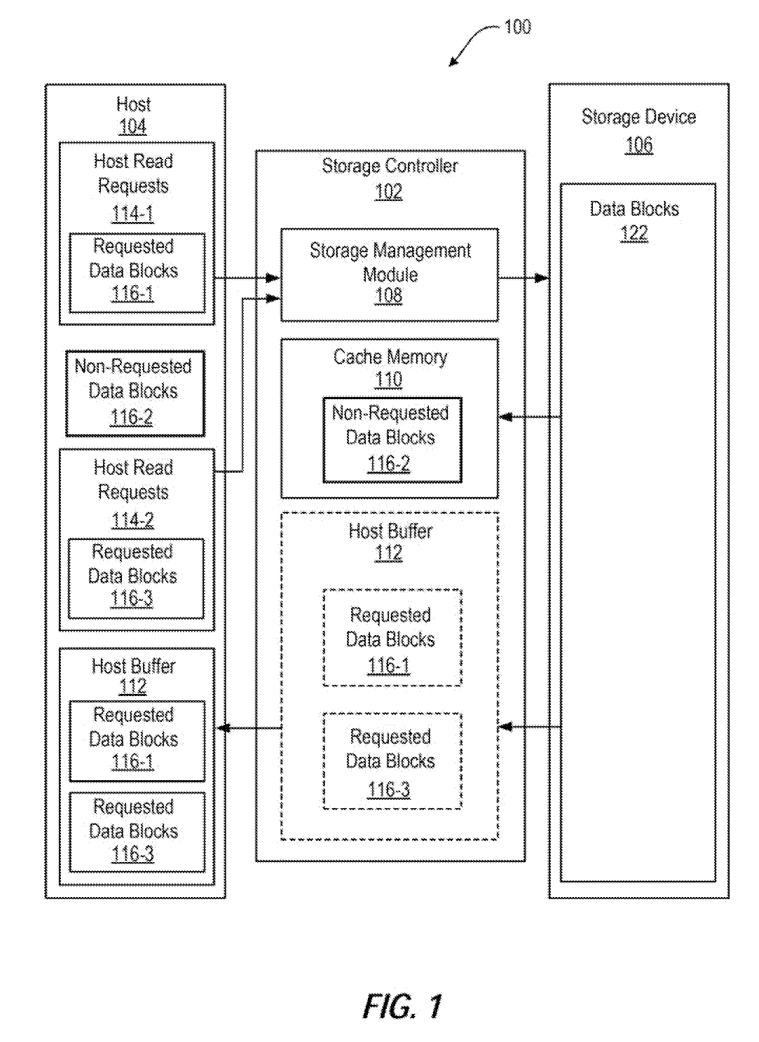

FIG. 1 depicts an example system 100 for management of storage read requests in accordance with an example of the techniques of the present application. The system 100 includes a storage controller 102 which may couple to be included in any type of computing device that interfaces with a memory, such as a secure microprocessor, a notebook computer, a desktop computer, an all-in-one system, a server, a network device, a wireless device and the like. In the embodiment of FIG. 1, storage controller 102 provides communication between host 104 and storage device 106.

The storage controller 102 may include, for example, a hardware device including electronic circuitry for implementing the functionality described herein, such as control logic and/or memory. In addition or as an alternative, the storage controller 102 may be implemented as a series of instructions encoded on a machine-readable storage medium and executable by a processor. For example, storage controller 102 may independently run an application and/or operating system (OS) for interfacing to storage device 106. The storage controller 102 may connect to host 104 to receive requests for access to storage device 106. The requests may include requests to write data blocks to storage device 106 and requests to read data blocks from the storage device. The host 104 may refer to any type of device that seeks to access the storage device 106, such as a main processor of a computer or a computer connected to a computer network and the like.

The storage device 106 is shown having data blocks 122 which may include groups of bits or bytes to store data or information which may be later retrieved. The storage device 106 may include a plurality of storage components which may be any electronic, magnetic, optical, or other physical storage device that contains or stores data and/or executable instructions, such as a hard disk drive (HDD), solid-state drive (SSD) and the like. In one example, storage controller 102 may configure storage device 106 through a virtualization process to virtualize the storage device to have storage volumes. In this manner, host 104 may access data blocks on storage device 106 through storage volumes that span multiple storage devices without having to have knowledge of the physical structure of the storage devices. In one example, storage controller 102 may communicate with storage device 106 through any communication means such as Serial Attached SCSI (SAS) connection and may communicate with host 104 through any communication means such as via a Peripheral Component Interconnect (PCI) connection and the like.

The storage controller 102 may exchange commands and data with host 104. For example, the storage controller 102 may receive a plurality of requests from host 104 which may include read and/or write accesses to sequential and/or random addresses of locations associated with data blocks stored on storage device 106. The storage controller 102 may be configured to communicate with storage device 106 over a storage interface to exchanged command and data over a bus. The storage device 106 may include a plurality of storage drives which may refer to storage mechanisms with fixed or removable media, such as separate HDDs and the like. The storage device 106 may further be based on a number of drives of the storage device that storage controller 102 is to access per request. For example, the plurality of storage drives of the storage device 106 may define a structure referred to as a redundant array of independent disks (RAID). In another example, storage device 106 may be configured as storage volumes. The storage volumes may be formed based on a virtualization process that includes mapping logical block address (LBA) to physical address of locations on physical storage devices such as hard disk drives. The host 104 may access storage device 106 using logical address without having to need to manage or know the physical address layout of the storage device 106. This mapping may depend on the RAID level implemented in storage device 106.

The storage controller 102 includes a storage management module 108 configured to manage storage read requests between host 104 and storage device 106. The storage management module 108 communicates with cache memory 110 for storage and later retrieval of data such as data blocks 122 of storage device 106. The cache memory 110 may be used by storage controller 102 to read data blocks 122 from the storage device 106 and return the data to host 104. The cache memory 110 may have a lower latency than that of the storage device 106. For instance, cache memory 110 may include double data rate (DDR) RAM while the storage device 106 may include a hard disk drive (HDD).

The storage management module 108 may be configured to implement the techniques of the present application which may help reduce storage device operations by coalescing or grouping non-continuous or discontinuous multiple small read requests together as single large read requests or operations.

The storage management module 108 may be configured to receive from host 104 multiple host read requests 114 to read sets or groups of data blocks 122 from data storage device 106. In one example, host 104 may send host read requests 114 for requested data blocks 116-1 and requested data blocks 116-3. The storage management module 108 may be configured to check whether the host read requests include non-continuous addresses associated with a set of non-requested data blocks between sets of requested data blocks and whether a gap of a number of non-requested data blocks is less then a pre-defined threshold. For example, to illustrate operation, it may be assumed that host read request 114-1 corresponds to a request for data blocks 116-1 located at an LBA of address 10 with Block Count of 2 blocks and read request 114-2 corresponds to a request for data blocks 116-3 located an LBA of address 15 with Block Count of 2 blocks. In this case, storage management module 108 determines that host read request 114-1 end host read request 114-2 include non-continuous addresses associated with a set of non-requested data blocks 116-2 located between sets of requested data blocks data block 116-1 and data blocks 116-3. In other words, there is an address gap between the LBA address of 10 and LBA address of 15 such that the LBA address of 10 and 15 correspond to the requested data blocks 116-1, 116-3 and the address gap represents the non-requested data blocks data blocks 116-2.

To further illustrate, it may be further assumed that the address gap includes a number of non-requested data blocks that is less than a pre-defined threshold. For example, the threshold may be based on several factors. For example, the threshold may include a predefined threshold ratio of the non-requested data size divided by requested data size. In one case, if the threshold ratio is less than 1, then storage management module 108 may combine the host read requests into a single host read request. On the other hand, if the threshold ratio is greater than 1, then storage management module 108 may not combine the multiple host read requests into a single host read request, but rather proceed to generate multiple read requests. In another example, storage management module 108 may be configured to determine whether to generate a single read request based on gap of a pre-defined threshold of number of sets or groups of non-requested data blocks between sets or groups of requested data blocks. In another example, storage management module 108 may be configured to determine whether to generate a single read request based on LBAs and number of data blocks associated with the host requests of the requested data blocks and non-requested data blocks.

The storage management module 108 may be configured to generate multiple host read requests to retrieve the requested data blocks from storage device 106. For example, if it assumed that the threshold ratio is greater than 1, then storage controller determines that it is beneficial to not combine the multiple host read requests into a single host read request. Rather, in this case, the storage management module 108 may generate multiple host read requests such as host read request 114-1 and host read request 114-2 to retrieve the set of respective requested data blocks 116-1, data block 116-3. In other words, storage management module 108 determines that there is an address gap between the LBA address of 10 and LBA address of 15 such that the LBA address of 10 and 15 correspond to the requested data blocks data blocks 116-1, data block 116-3 and the address gap represents the non-requested data blocks data blocks 116-2. In one example, storage management module 108 returns data blocks 116-1, data block 116-3 back to host 104 by writing the data blocks to host 104.

The storage management module 108 may be configured to generate a single host read request to retrieve from storage device 106 the non-requested and requested data blocks. For example, if it assumed that the threshold ratio is less than 1, then storage management module 108 determines that it is beneficial to combine the multiple host read requests into a single host read request. In this case, the storage management module 108 may generate a single host read request that combines the read requests such as host read request 114-1 and host read request 114-2 to retrieve the set of requested data blocks 116-1, 116-3 and to retrieve the set of non-requested data blocks 116-2 located between the sets of requested data blocks. In this case, there is an address gap between the LBA address of 10 and LBA address of 15 such that the LBA address of 10 and 15 correspond to requested data blocks 116-1, 116-3 and the address gap represents the non-requested data blocks 116-2. Although there is the address gap, storage management module 108 determines that it is beneficial to combine the multiple read requests into a single host read request.

The storage management module 108 may be configured to directly write the retrieved requested data blocks to host buffer 112. To illustrate, continuing with the above example, it may be assumed that storage management module 108 generates a single read request that combines the read requests such as host read request 114-1, and host read request 114-2 to retrieve the set of requested respective data block 116-1, data block 116-3. In this case, storage management module 108 may directly write the retrieved requested data block 116-1 and data block 116-3 to host buffer 112 of host 104. In one example, storage management module 108 may be configured to receive from host 104, as part of the read requests or other transactions, addresses of locations associated with the host buffer.

In this manner, storage management module 106 may use the addresses of the host buffers to directly write the requested data blocks retrieved from the storage device to the addresses of locations associated with the host buffer. The storage management module 108 may be configured to receive from host 104 host requests for data blocks that include address information such as LBAs associated With the sets of data blocks end a number of data blocks beginning from the LBA or any other type of address information to write to the host buffer of the host. The host buffer 112 shown associated with storage controller 102 in dashed lines represents that the storage controller receives the addresses of the host buffer 112 of host 104 and writes the data blocks to the address of the host buffer 112 located on host 104 and not to memory of the storage controller. In this manner, storage controller 102 may directly write data blocks to host buffer 112 of host 104 instead of having to write the data to the storage controller and without having to read it from the storage controller and then having to write it to the host. This technique may help reduce storage controller 102 memory access bandwidth and thereby help improve storage performance.

The storage management module 108 may be configured to then write the non-requested data blocks 116-2 to cache memory 110 associated with storage management module 108 to allow for return to host 104 in case of a subsequent host read request. To illustrate, continuing with the above example, it may be assumed that storage management module 108 generates a single host read request that combines the read requests such as host read request 114-1 and host read request 114-2 to retrieve the set of requested respective data blocks data block 116-1, data block 116-3. In addition, the single host read request included a request for the set of non-requested data blocks 116-2. In this case, storage management module 108 may write the non-requested data blocks 116-3 to cache memory 110 of the storage controller 102. In this manner, the storage controller 102 may allow for the return of the data in cache memory to the host in case of a subsequent host read request.

For example, storage management module 108 may be configured to receive from host 104 another or subsequent request for data blocks that includes non-requested data blocks 116-2 previously stored on cache memory 110. In this case, storage management module 108 may detect the host request and respond with a read of the previous non-requested data blocks 116-2 stored on cache memory 110 and then return the data blocks to the host instead of having to read the data blocks from storage device 108. In this case, instead of discarding the non-requested data blocks, storage controller 102 may allocate memory such as a buffer or cache memory to store the data blocks for possible subsequent request from the host. It may be beneficial to save the data blocks to cache memory because the storage controller already expended resources to transfer the data blocks from storage device 106 to storage controller. In this manner, storage management module 108 may avoid having to generate another read request directed to storage device 106 which may improve storage performance.

It should be understood that the above example configuration is for illustrative purposes and that other examples and configurations may be possible to practice the techniques of the present application. For example, the functionality and operation of storage management module 108 may be distributed among different separate functional modules, distributed across remote locations, integrated in one device, or a combination thereof and the like. The above example was described in the context of system 100 with arrangements of devices such as host 104, storage controller 102 and storage device 106. However, it should be understood that the techniques of the present application may be implemented with a different arrangement of system 100 such as multiple hosts 104, multiple storage controllers 102, multiple storage devices 106 and the like, for example. The above was described in the context of particular arraignments of host read requests and data block configurations. However, it should be understood that the techniques of the present application may be implemented with a different arrangement of host read requests and data block arrangements, for example.

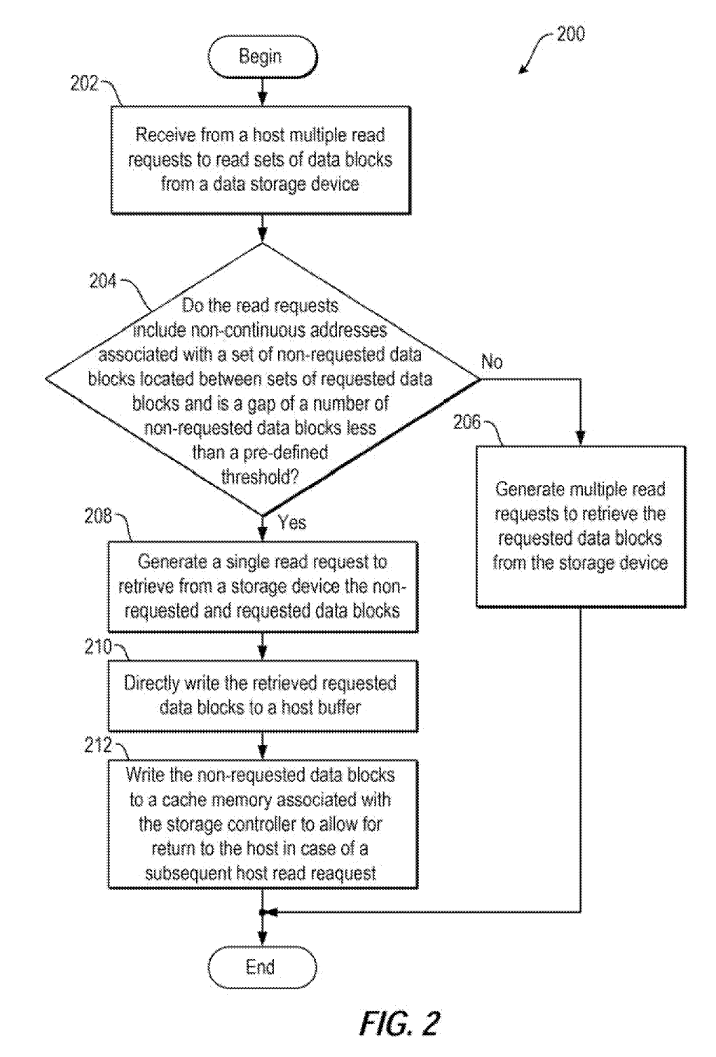

FIG. 2 depicts an example flow chart of a process 200 for management of storage read request in accordance with an example of the techniques of the present application.

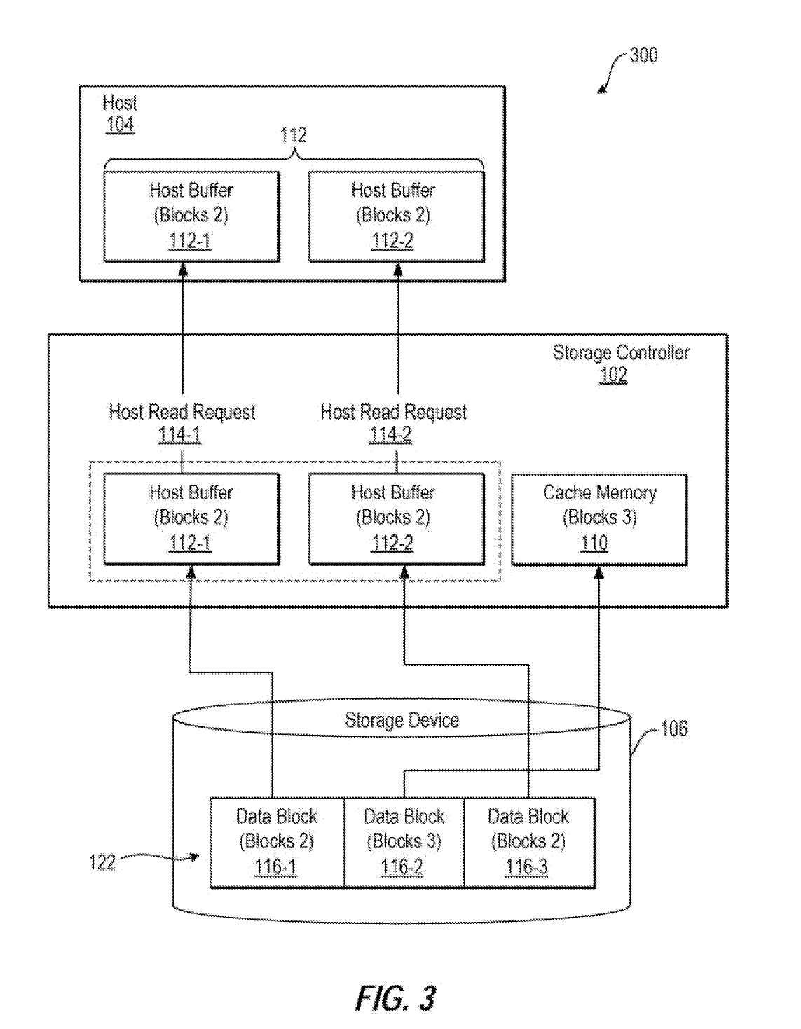

In some implementations, such process 200 may be conducted by the previously-mentioned storage controller 102. To illustrate operation of the management of storage read requests of the present application, process 200 will be described Ii conjunction with example system 300 of FIG. 3. The system 300 is similar to system 100 of FIG. 1 in which the system 300 includes host 104 coupled to storage controller 102 to communicate with storage device 106. The functionality and operation of the components of system 300 is similar to those of system 100 described above.

The process 200 may begin at block 202, where storage controller 102 receives from host 104 multiple read requests 114 to read sets or groups of data blocks from data storage device 106. For example, in one example, storage management module 108 receives from host 104 multiple read requests 114 to read sets of data blocks 122 from data storage device 106. In this example, host 104 sends host read requests 114-1, 114-2 corresponding to respective data blocks 116-1, 116-3. Once storage management module 108 receives from host 104 multiple read requests, processing proceeds to block 204.

At block 204, storage controller 102 checks whether the read requests include non-continuous addresses associated with a set or group of non-requested data blocks between sets or groups of requested data blocks and a gap of a number of non-requested data blocks is less than a pre-defined threshold. If so, then processing proceeds to block 208 where storage controller 102 proceeds to generate a single read request. For example, continuing with the above example, suppose that host read request 114-1 corresponds to a request for data blocks 116-1 located at an LBA of address 10 with Block Count of 2 blocks and host read request 114-2 corresponds to a request for data blocks 116-3 located an LBA of address 15 with Block Count of 2 blocks. In this case, storage controller 102 determines that host read request 114-1 and host read request 114-2 include non-continuous addresses associated with a set of non-requested data blocks 116-2 located between sets of requested data blocks 116-1 and 116-3. In other words, storage controller 102 determines that there is an address gap between the LBA address of 10 and LBA address of 15 such that the LBA address of 10 and 15 correspond to the requested data blocks 116-1 and 116-3 and the address gap represents the non-requested data blocks 116-2.

To further illustrate, it may be further assumed that the address gap includes a number of non-requested data blocks that is less than a pre-defined threshold. For example, the threshold may be based on several factors such a predefined threshold ratio of the non-requested data size divided by requested data size. In one case, if the threshold ratio is less than 1, then storage controller 102 may combine the read requests into a single read request. To illustrate, it may be assumed that the threshold ratio is less than 1 and that storage controller 102 may combine the host read requests into a single read request. In this case, processing may proceed to block 208 where storage controller 102 proceeds to combine the multiple read requests into a single read request.

On the other hand, it the threshold ratio is greater than 1, then storage controller does not combine the multiple read requests into a single read request. In this case, processing proceeds to block 206 where storage controller 102 proceeds to generate multiple read requests.

At block 206, storage controller 102 generates multiple read requests to retrieve the requested data blocks from the storage device. For example, if it assumed that the threshold ratio is greater than 1, then storage controller determines that it is beneficial to not combine the multiple read requests into a single read request. Rather, In this case, storage controller 102 may generate multiple read requests such as 114-1, 114-2 to retrieve the set of requested data blocks 116-1, 116-3 In other words, there is an address gap between the LBA address of 10 and LBA address of 15 such that the LBA address of 10 and 15 correspond to the requested date blocks 116-1, 116-3 and the address gap represents the non-requested date blocks 116-2. In one example, the storage controller 102 returns the data blocks 116-1 and 116-3 back to host 104 by writing the data blocks to respective host buffers 112-1, 112-2. Once storage controller 102 generates the multiple read requests, processing proceeds to the End block. In other example, processing may proceed back to block 202 to continue to process further receipt of read requests from the host.

At block 208, storage controller 102 generates a single read request to retrieve from storage device the non-requested and requested data blocks. For example, if it assumed that the threshold ratio is less than 1, then storage controller 102 determines that it is beneficial to combine the multiple host read requests into a single host read request. In this case, the storage controller 102 may generate a single read request that combines the read requests such as 114-2 and 114-2 to retrieve the set of requested data blocks 116-1, 116-3 and to retrieve the set of non-requested data blocks 116-2 located between the sets of requested data blocks. In this case, storage controller 102 determines that there is an address gap between the LBA address of 10 and LBA address of 15 such that the LBA address of 10 and 15 correspond requested data blocks 116-1, 116-3 and the address gap represents the non-requested data blocks 116-2. Although there is the address gap, storage controller 102 determines that it is beneficial to combine the multiple read requests into a single read request. Once storage controller 102 generates a single read request, processing proceeds to block 210.

At block 210, storage controller 102 directly writes the retrieved requested data blocks to a host buffer. To illustrate, continuing with the above example, it may be assumed that the storage controller 102 generates a single read request that combines the read requests such as 114-1 and 114-2 to retrieve the set of requested respective data blocks 116-1, 116-3. In this case, storage controller 102 directly writes the retrieved requested data blocks 116-1, 116-3 to respective host buffers 112-1, 112-2. In this case, storage management module 108 may directly write the retrieved requested data block 116-1, data block 116-3 to host buffer 112 of host 104. The host buffer 112 shown that is associated with storage controller 102 in dashed lines represents that the storage controller receives the addresses of the host buffer 112 of host 104 and then the storage controller writes the data blocks to the address of the host buffer 112 located on host 104 end not to memory of the storage controller. In other words, storage controller 102 receives addresses of the host buffer of host 104 and then writes the data blocks to the address of the host buffer located on host 104. In this manner, storage controller 102 may directly write data blocks to host buffer 112 of host without having to write the data to the storage controller, then have to read it from memory of the storage controllers, and then write it to the host. This technique may help reduce storage controller 102 memory access bandwidth and thereby help improve storage performance. Once storage controller 102 directly writes the retrieved requested data blocks to the host buffer, processing proceeds to block 212.

At block 212, storage controller 102 writes the non-requested data blocks to a cache memory associated wild the storage controller to allow for return to the host in case of a subsequent host read request. To illustrate, continuing with the above example, it may be assumed that the storage controller 102 generates a single read request that combines the read requests such as 114-1 and 114-2 to retrieve the set of requested - respective data blocks 116-1, 116-3. In addition, the single read request included a request for the set of non-requested data blocks 116-2. In this case, storage controller 102 writes the non-requested data blocks 116-2 to cache memory 110 of the storage controller. In this manner, the storage controller 102 may allow for the return of the data in cache memory to the host in case of a subsequent host read request. For example, storage controller 102 may be configured to receive from host 104 another request for data blocks that includes non-requested data blocks 116-2 previously stored on cache memory 110. The storage controller 102 may respond to the host request with a read of the previous non-requested data blocks 116-2 stored on cache memory 110 and return the data blocks to the host instead of a read of the data blocks from the storage device. In this manner, storage controller 102 may avoid having to generate another read request directed to storage device 106 which may improve performance. Once storage controller 102 writes the non-requested data blocks 116-2 to cache memory 110, processing proceeds to the End block. In other example, processing may proceed back to block 202 to continue to process further receipt of read requests from the host.

It should be understood that the above example configuration is for illustrative purposes and that other examples and configurations are possible to practice the techniques of the present application. For example, the functionality of storage management module 108 may be distributed among different separate functional modules, distributed across remote locations, integrated in one device, a combination thereof and the like. The above example was described in the context of system 300 with arrangements of devices such as host 104, storage controller 102 and storage device 106. However, it should he understood that the techniques of the present application may be implemented with a different arrangement of system 300 such as multiple hosts 104, storage controllers 102 and storage devices 106. The above was described in the context of a particular arrangement of host read requests and data block configurations. However, it should be understood that the techniques of the present application may be implemented with a different arrangement host read requests and data block configurations.

It should also be readily apparent that the process depicted in FIG. 2 represents generalized illustrations, and that other processes may be added or existing processes may be removed, modified, or rearranged without departing from the scope and spirit of the present application. In addition, it should be understood that the processes may represent instructions stored on a processor-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific Integrated circuits (ASICs), or other hardware components associated with a storage controller. Furthermore, the flow charts are not intended to limit the implementation of the present application, but rather the flow charts illustrate functional information that one skilled in the art could use to design/fabricate circuits, generate software, or use a combination of hardware and software to perform the illustrated processes.

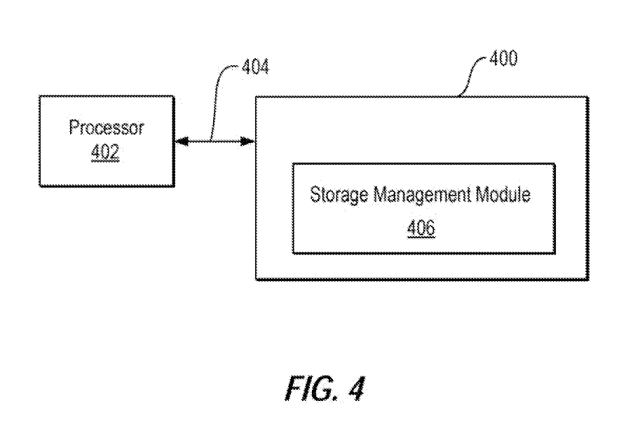

FIG. 4 is an example block diagram showing a non-transitory, computer-readable medium that stores code for management of storage read requests in according with the techniques of the present application. The non-transitory, computer-readable medium is generally referred to by the reference number 400 and may be included in storage controller 102 described in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate a storage controller in accordance with an example. In an example, the tangible, machine-readable medium 400 may be accessed by the processor 402 over a bus 404. A first region 406 of the non-transitory, computer-readable medium 400 may include storage management module functionality as described herein.

Although shown as contiguous blocks, the software components may be stored in any order or configuration. For example, if the non-transitory, computer-readable medium 400 is a hard drive, the software components may be stored in non-contiguous, or even overlapping, sectors.

The foregoing may describe a novel and previously unforeseen approach to management of storage read requests. While the above application has been shown and described with reference to the foregoing examples, it should be understood that other forms, details, and implementations may be made without departing from the spirit and scope of the application that is defined in the following claims.

What is claimed is:

1. A storage controller to manage storage read requests, comprising:
a cache memory; and
a storage management module to:
receive from a host multiple read requests to read sets of data blocks from a data storage device,
determine whether the read requests include non-continuous addresses associated with a set of non-requested data blocks located between sets of requested data blocks and a gap of a number of non-requested data blocks is less than a pre-defined threshold, and
If the read requests have non-continuous addresses and a gap of a number of non-requested data blocks is less than the pre-defined threshold, then generate a single read request to retrieve from a storage device the non-requested and requested date blocks, and directly write the retrieved requested data blocks to a host buffer, and write the retrieved non-requested data blocks to the cache memory to allow for return to the host in case of a subsequent host read request, otherwise generate multiple read requests to retrieve only the requested data blocks from the storage device.

2. The storage controller of claim 1, wherein the storage management module is to receive from the host as part of the read requests addresses of locations associated with the host buffer, and wherein the storage management module to write the requested data blocks retrieved from the storage device to the addresses of locations associated with the host buffer.

3. The storage controller of claim 1, wherein the storage management module is further configured to receive from the host another request for data blocks that includes non-requested data blocks previously stored on the cache memory, wherein the storage management module to respond with a read of the previous non-requested data blacks stored on the cache memory and return the data blocks to the host instead of a read of the data blocks from the storage device.

4. The storage controller of claim 1, wherein the storage management module is configured to receive host requests for data blocks that include logical block addresses (LBAs) associated with the sets of data blocks and a number of data blocks beginning from the LBA.

5. The storage controller of claim 1, wherein the storage management module is configured to communicate with the storage device over a storage interface with the storage device configured as a redundant array of independent disk (RAID).

6. The storage controller of claim 1, wherein the storage management module is configured to determine whether to generate a single read request based on gap of a pre-defined threshold of number of sets of non-requested data blocks between sets of requested data blocks.

7. The storage controller of claim 1, wherein the storage management module is configured to determine whether to generate a single read request based on LBAs and number of data blocks associated with the host requests of the requested data blocks and the non-requested data blocks.

8. A method for managing storage read requests, comprising:
receiving, at a storage management module of a controller, from a host multiple read requests to read sets of data blocks from a data storage device;
determining, at the storage management module of the controller, whether the read requests include non-continuous addresses associated with a set of non-requested data blocks located between sets of requested data blocks and a gap of a number of non-requested data blocks is less than a pre-defined threshold; and
If the storage management module of the controller determining that the read requests have non-continuous addresses and a gap of a number of non-requested data blocks is less than the predefined threshold, than generating a single read request to retrieve from a storage device the non-requested and requested data blocks, and directly write the retrieved requested date blocks to a host buffer, and writing the retrieved non-requested data blocks to a cache memory associated with the storage controller to allow for return to the host in case of a subsequent host read request, otherwise generating multiple read requests to retrieve only the requested data blocks from the storage device.

9. The method of claim 8, further comprising the storage management module receiving from the host as part of the read requests addresses of locations associated with the host buffer, and wherein the storage management module writing the requested data blocks retrieved from the storage device to the addresses of locations associated with the host buffer.

10. The method of claim 8, further comprising the storage management module further receiving from the host another request for data blocks that includes previous non-requested data blocks stored on the cache memory, wherein the storage management module further responding with a read of the previous non-requested data blocks stored on the cache memory and returning the data blocks to the host instead of a read of the data blocks from the storage device.

11. The method of claim 8, further comprising the storage management module receiving host requests for data blocks that include logical block addresses (LBAs) associated with the sets of data blocks and a number of data blocks beginning from the LBA.

12. The method of claim 8, further comprising the storage management module communicating with the storage device over a storage interface with the storage device configured as a redundant array of independent disk (RAID).

13. The method of claim 8, further comprising the storage management module determining whether to generate a single read request based on a gap of a pre-defined threshold number of sets of non-requested data blocks between sets of requested data blocks.

14. The method of claim 8, further comprising the storage management module determining whether to generate a single read request based on LBAs and number of data blocks associated with the host requests of the requested data blocks and the non-requested data blocks.

15. A non-transitory computer-readable medium having computer executable instructions stored thereon for management of storage read requests, the instructions are executable by a processor to:
receive from a host multiple read requests to read sets of data blocks from a data storage device;
determine whether the read requests include non-continuous addresses associated with a set of non-requested data blocks located between sets of requested data blocks and a gap of a number of non-requested data blocks is less than a pre-defined threshold; and
If the read requests have non-continuous addresses and a gap of a number of non-requested data blocks is less than the pre-defined threshold, then generate a single read request to retrieve from a storage device the non-requested and requested data blocks, and directly write the retrieved requested data blocks to a host buffer, and write the retrieved non-requested data blocks to a cache memory to allow for return to the host in case of a subsequent host read request, otherwise generate multiple read requests to retrieve only the requested data blocks from the storage device.

16. The non-transitory computer-readable medium of claim 15, further comprising instructions that if executed cause a processor to: receive from the host as part of the read requests addresses of locations associated with the host buffer, and write the requested data blocks retrieved from the storage device to the addresses of locations associated with the host buffer.

17. The non-transitory computer-readable medium of claim 15 further comprising instructions that if executed cause a processor to: receive from the host another request for data blocks that includes previous non-requested data blocks stored on the cache memory, and respond with a read of the previous non-requested data blocks stored on the cache memory and return the data blocks to the host instead of a read of the data blocks from the storage device.

18. The non-transitory computer-readable medium of claim 15 further comprising instructions that if executed cause a processor to: receive host requests for data blocks that include logical block addresses (LBAs) associated with the sets of data blocks and a number of data blocks beginning from the LBA.

19. The non-transitory computer-readable medium of claim 15 further comprising instructions that if executed cause a processor to: communicate with the storage device over a storage interface with the storage device configured as a redundant array of Independent disk (RAID).

20. The non-transitory computer-readable medium of claim 15 further comprising instructions that if executed cause a processor to: determine whether to generate a single read request based on a gap of pre-defined threshold number of sets of non-requested data blocks between sets of requested data blocks.
